(19) United States
(12) Patent Application Publication
(10) Pub. No.: US 2018/0046994 A1
(43) Pub. Date: Feb. 15, 2018

(54) METHOD AND SYSTEM FOR RESTRICTING TRANSACTIONS TO ALLOWED PRODUCTS

(71) Applicant: MasterCard International Incorporated, Purchase, NY (US)

(72) Inventors: Pia MAENPAA, White Plains, NY (US); Danielle Jean EININGER, New City, NY (US); Heather L. THOMAS, Brooklyn, NY (US); Matthew HARRIS, St. Peters, MO (US)

(73) Assignee: MasterCard International Incorporated, Purchase, NY (US)

(21) Appl. No.: 15/232,193

(22) Filed: Aug. 9, 2016

(51) Int. Cl. G06Q 20/10; G06F 17/30; G06Q 20/32

(52) U.S. Cl. CPC G06Q 20/10; G06Q 20/3278; G06F 17/30864

(57) ABSTRACT

A method for identification of pre-approved products in a limited use account includes: storing, in a memory of a computing device, at least an account identifier; receiving, by an input device of the computing device, one or more product identifiers; electronically transmitting, by a transmitting device of the computing device, at least the account identifier and one or more product identifiers to a first computing system; receiving, by a receiving device of the computing device, an indication of at least one of the one or more product identifiers as a pre-approved identifier from the first computing system; and electronically transmitting, by the transmitting device of the computing device, at least the at least one product identifier indicated as a pre-approved identifier to a second computing system.

### FIELD

The present disclosure relates to the restricting of payment transactions to allowed products, specifically the identification of pre-approved products for a limited use transaction account for purchase in a payment transaction.

### BACKGROUND

Many consumers have resorted to using transaction accounts in place of cash for funding every day payment transactions. However, there may be instances where a consumer may want to limit the usage of their transaction account, particularly in instances where they may authorize another person to use their transaction account. For example, an employer may provide an employee with a payment card associated with a business's transaction account, or a parent may provide their child with a payment card for their transaction account, for use in specific payment transactions.

In order to control the usage of payment cards issued on a transaction account, some methods have been developed to enable transaction controls to be placed on a transaction account. Transaction controls place limits on the usage of a payment card, transaction account, or a specific account number for a transaction account, that may limit usage for one or more payment transactions, such as based on the transaction amount, an aggregate spending amount, number of transactions, frequency of transactions, geographic location, merchant category, etc. However, transaction controls are often limited to values of the transaction itself, without regard to the specific products being purchased. In many instances, transaction systems are unable to capture product data for products for which purchase is attempted during the authorization process. In addition, transaction controls are often applied during authorization, when the consumer has already selected their items and presented them for checkout. In such cases, if the transaction controls are exceeded, the transaction may be declined, which may be time-consuming for both the consumer and merchant, and be embarrassing for the consumer.

Thus, there is a need for a technical solution to enable for identification of pre-approved products for purchase using a limited-use transaction account prior to initiation of a corresponding payment transaction.

### SUMMARY

The present disclosure provides a description of systems and methods for identification of pre-approved products in a limited use account. Identification of products that are pre-approved for purchase prior to the initiation of a payment transaction may ensure that the ensuing payment transaction is authorized and approved, which may be more efficient for both consumers and merchants, and may save the consumer from potential embarrassment. In addition, the ability to control what products may be purchased, and to be able to identify such products via a computing device, may allow an account holder to easily control, and utilize, a transaction account with a high level of efficiency.

A method for identification of pre-approved products in a limited use account includes: storing, in a memory of a computing device, at least an account identifier; receiving, by an input device of the computing device, one or more product identifiers; electronically transmitting, by a transmitting device of the computing device, at least the account identifier and one or more product identifiers to a first computing system; receiving, by a receiving device of the computing device, an indication of at least one of the one or more product identifiers as a pre-approved identifier from the first computing system; and electronically transmitting, by the transmitting device of the computing device, at least the at least one product identifier indicated as a pre-approved identifier to a second computing system.

A system for identification of pre-approved products in a limited use account includes: a memory of a computing device configured to store at least an account identifier; an input device of the computing device configured to receive one or more product identifiers; a transmitting device of the computing device configured to electronically transmit at least the account identifier and one or more product identifiers to a first computing system; and a receiving device of the computing device configured to receive an indication of at least one of the one or more product identifiers as a pre-approved identifier from the first computing system, wherein the transmitting device of the computing device is further configured to electronically transmit at least the at least one product identifier indicated as a pre-approved identifier to a second computing system.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for identifying pre-approved products for purchase with a limited use transaction account in accordance with exemplary embodiments.

FIG. 2 is a block diagram illustrating a computing device for use in identifying pre-approved products for purchase with a limited use transaction account for use in the system of FIG. 1 in accordance with exemplary embodiments.

FIG. 3 is a flow diagram illustrating a process for identifying pre-approved products for purchase using the computing device of FIG. 2 in accordance with exemplary embodiments.

FIGS. 4A-4D are diagrams illustrating exemplary graphical user interfaces of the computing device of FIG. 2 for the identification of pre-approved products for purchase with a limited use transaction account in accordance with exemplary embodiments.

FIG. 5 is a flow chart illustrating an exemplary method for identification of pre-approved products in a limited use account in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

### System for Identification of Pre-Approved Products

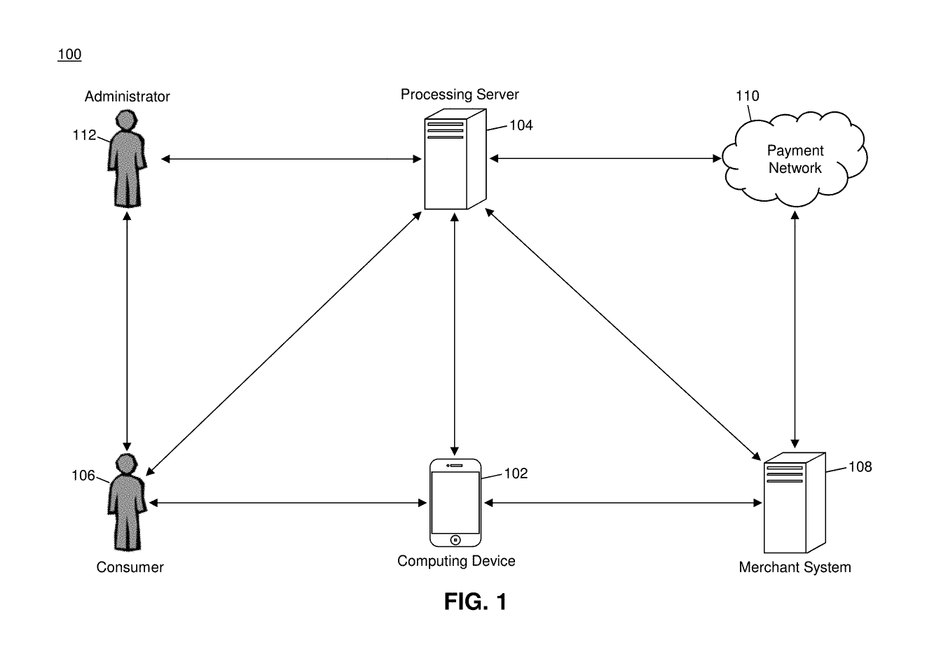

FIG. 1 illustrates a system 100 for the identification of pre-approved products for purchase in a payment transaction with a limited use transaction account, where the products may be identified prior to the initiation of the corresponding payment transaction using a computing device 102.

In the system 100, a computing device 102 may be used to identify products prior to the initiation of a payment transaction that are pre-approved for purchase using a limited use transaction account. The computing device 102, discussed in more detail below, may be any type of specifically configured computing device suitable for performing the functions discussed herein, such as a specifically configured desktop computer, laptop computer, notebook computer, tablet computer, cellular phone, smart phone, smart watch, smart television, wearable computing device, implantable computing device, etc. The computing device 102 may electronically communicate with a processing server 104, which may be configured to perform secondary checks regarding the approval of products selected for purchase using the computing device 102.

In the system 100, a consumer 106 may, as a user of the computing device 102, be interested in setting limits on products that may be purchased using their transaction account. The consumer 106 may register their transaction account with the processing server 104. As part of the registration, the consumer 106 may be assigned or may select a unique identifier to be associated with the consumer 106 for identification thereof in communications between the consumer 106 and processing server 104, such as may be performed using the computing device 102. Such an identifier may be referred to herein as an account identifier, and may be a username, e-mail address, telephone number, device identifier (e.g., media access control address, internet protocol address, or other identifier of the computing device 102), etc. In some instances, a primary account number associated with the transaction account may be used as the account identifier.

During or subsequent to the registration process, the consumer 106 may select one or more products for pre-approval for purchase in subsequent payment transactions using the computing device 102. In some instances, the consumer 106 may provide data associated with pre-approved products via the computing device 102, such as using one or more input fields where the consumer 106 may input data associated with each pre-approved product, such as a product identifier. In other instances, the consumer 106 may select (e.g., via a web page, application program, or other suitable interface with the processing server 104) products for pre-approval, such as a from a displayed list or catalog of products. In some cases, all products may be pre-approved by default, where the consumer 106 may select products that are to be removed from the list of pre-approved products.

The processing server 104 may be configured to keep track of the pre-approved products for the consumer 106 using the consumer's account identifier and a product identifier for each of the pre-approved products. The product identifier may be a unique value associated with the corresponding product used for identification thereof, such as a universal product code, registration number, serial number, European article number, stock-keeping unit, international standard book number, etc. In some embodiments, the registration and product selection processes may be handled solely in the computing device 102. In such an instance, an application program specifically configured to perform the functions discussed herein may be installed in the computing device 102, which may store the pre-approved product identifiers internally using local memory, or in external memory that may be accessed using cloud computing techniques. Accordingly, the computing device 102 may be configured to perform the functions of the processing server 104 as discussed herein.

The consumer 106 may then proceed to shop using the computing device 102. While shopping, the consumer 106 may select products to purchase, and may use the computing device 102 to determine if each selected product is pre-approved, and therefore allowed for purchase. The computing device 102 may include one or more input devices with which a product identifier for each selected product may be input. In one example, the computing device 102 may include a keyboard or other user input device where the consumer 106 may manually input the product identifier. In another example, the computing device 102 may have an optical imaging device, such as a camera or a bar code reader, which may be configured to read a machine-readable code, such as a bar code or a quick response code, that is encoded with the product identifier. The consumer 106 may, using the input devices of the computing device 102, enter or otherwise accommodate the input of the product identifiers for each of the selected products.

The computing device 102 may then identify, for each selected product, if the product is pre-approved for purchase. In instances where the computing device 102 may store such data locally or otherwise have access to the data, the computing device 102 may identify if the product identifier for each selected product is in the list of pre-approved products as registered by the consumer 106. In instances where the processing server 104 may store the account information, the computing device 102 may electronically transmit a data signal to the processing server 104 using a suitable communication method and network, such as a cellular communication network or the Internet, which may be superimposed or otherwise encoded with the product identifiers of the selected products, and the consumer's 106 account identifier, if applicable. The processing server 104 may then identify if each product identifier provided by the computing device 102 is in the list of pre-approved products, and return an indication for each product identifier to the computing device 102 that indicates if the corresponding product is pre-approved or is not approved.

The computing device 102 may then, based on its own determination or that received from the processing server 102, have indications for each selected product if the product is pre-approved or not. The computing device 102 may, using a suitable display or other type of output device, inform the consumer 106 of the status of each of the selected products. The consumer 106 may then be aware of which of the selected products may be purchased in the payment transaction and which may not. The consumer 106 may then proceed to initiate a payment transaction with the merchant.

In some embodiments, the consumer 106 may provide the pre-approved products to a merchant system 108 associated with the merchant using traditional methods. For instance, the consumer 106 may, in an in-person transaction, provide only the pre-approved products to the merchant at the point of sale. In an online transaction, the consumer 106 may remove all products that have not been pre-approved from their shopping cart prior to the checkout process. In other embodiments, the computing device 102 may be configured to electronically transmit the product identifiers for the selected and pre-approved products to the merchant system 108 using a suitable communication method. Suitable communication methods may include, for example, an electronic transmission of a data signal to the merchant system 108 via near field communication, the display of a machine-readable code encoded with each of the product identifiers, etc.

The merchant system 108 may then receive each of the product identifiers and may initiate the processing of a payment transaction for the corresponding products. In some embodiments, the merchant system 108 may be configured to identify if the products presented for purchase are approved for purchase by the consumer 106. In such embodiments, the computing device 102 may communicate the account identifier to the merchant system 108, and the merchant system 108 may electronically transmit the account identifier and the product identifiers for each of the presented products to the processing server 104. The processing server 104 may identify if the presented products are pre-approved, based on the product identifiers, and provide indications of the status of each of the products back to the merchant system 108. In such an embodiment, if a presented product is not pre-approved, the merchant system 108 may remove that product from the transaction to prevent purchase by the consumer 106. In some instances, the product may not be removed, but may not be purchased using the transaction account for which is it not pre-approved.

The merchant system 108 may then initiate the processing of the payment transaction by calculating a total transaction amount and/or otherwise identifying any necessary transaction data and electronically transmitting the transaction data to a payment network 110 for processing of the payment transaction. In some embodiments, the transaction data may include the product identifiers for the products being purchased. The transaction data may also include payment credentials associated with a transaction account being used to fund the payment transaction. In some embodiments, the payment credentials may be electronically transmitted to the merchant system 108 from the computing device 102. For example, the computing device 102 may include an electronic wallet application program, which may be the same application program used to identify pre-approval of selected products, which may be configured to electronically transmit payment credentials to merchant systems 108. In some such instances, the application program may be configured to prevent the transmission of payment credentials unless each of the products being purchase has been pre-approved by the computing device 102 or processing server 104.

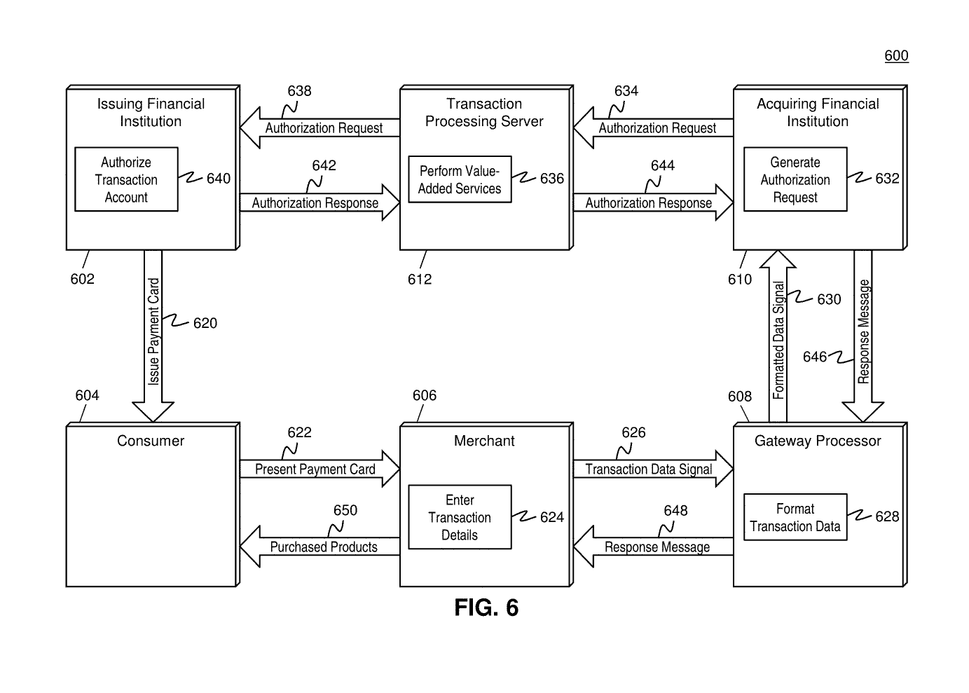

The transaction data may be electronically transmitted directly to the payment network 110 by the merchant system 108 or via one or more intermediate entities, such as an acquiring institution or gateway processor. In some cases, the transaction data may be included in a transaction message, which may be formatted by the merchant system 108 or one of the intermediate entities prior to electronic transmission to the payment network 110 via payment rails associated therewith. Transaction messages may be specially formatted data messages that are formatted pursuant to one or more standards governing the exchange of financial transaction messages, such as the International Organization of Standardization's ISO 8583 or ISO 20022 standards. Additional information regarding transaction messages, the data included therein, and the processing thereof, is discussed in more detail below with respect to the process 600 illustrated in FIG. 6.

In some embodiments, the processing server 104 may be configured to identify if approved products are being purchased during processing of the payment transaction. In such embodiments, the payment network 110 may electronically transmit the transaction message or product identifiers included therein to the processing server 104, which may determine if each of the product identifiers is approved for purchase using the registered transaction account. If one or more of the products are not approved, the processing server 102 may return an authorization response to the payment network 110 that indicates denial of the payment transaction due to the selection of an unapproved product for purchase. If all of the products are approved, the processing server 104 may return the transaction message to the payment network 110 or forward the transaction message to an issuing financial institution for further processing. The payment transaction may then be processed using traditional methods and systems for the processing of a payment transaction.

In some embodiments, the system 100 may include an administrator 112. The administrator 112 may be an account holder or other authorized user of the transaction account that is registered with the processing server 104 and/or computing device 102 for the limited use account for which only pre-approved products may be purchased. The administrator 112 may be a user that performs the registration of the products that are pre-approved for purchase, for which the consumer 106 may be subject to compliance. For instance, the administrator 112 may be an employer and the consumer 106 an employee, where the employee may only be able to purchase products that are pre-approved by their employer. In another example, the administrator 112 may be a parent and the consumer 106 their child, where the parent may limit the products that can be approved by the child. In such embodiments, the consumer 106 may be unable to modify the pre-approval status of products. In these instances, the consumer 106 may use the computing device 102 during shopping to identify if products are pre-approved by the administrator 112 for purchase, which may enable the consumer 106 to know, prior to presenting the products to the merchant system 108, if they are able to purchase what they are selecting.

The methods and systems discussed herein may thus enable a consumer 106 to shop confidently, knowing that the products they present to the merchant system 108 for purchase at the time of initiating a payment transaction are all approved for purchase. As a result, a consumer 106 may be saved from a potentially embarrassing situation where they may present products that they are prohibited from purchasing, as the consumer 106 would know well ahead of time via the functions performed by the specifically configured computing device 102 as discussed herein. The pre-approval of products themselves may also provide for more control for account holders, such as consumers 106 or administrators 112, than with traditional transaction controls, and may also provide for more flexibility, as purchases for products that are pre-approved may be performed successfully, without being subject to various purchasing limits that may exist with traditional transaction control systems. As a result, the methods and systems discussed herein provide for a technical solution that enables a consumer 106 to have a high level of control over what products are purchased, while maintaining flexibility and ensuring that the controls are applied prior to initiating a payment transaction to enable the consumer 106 to transact more confidently.

### Computing Device

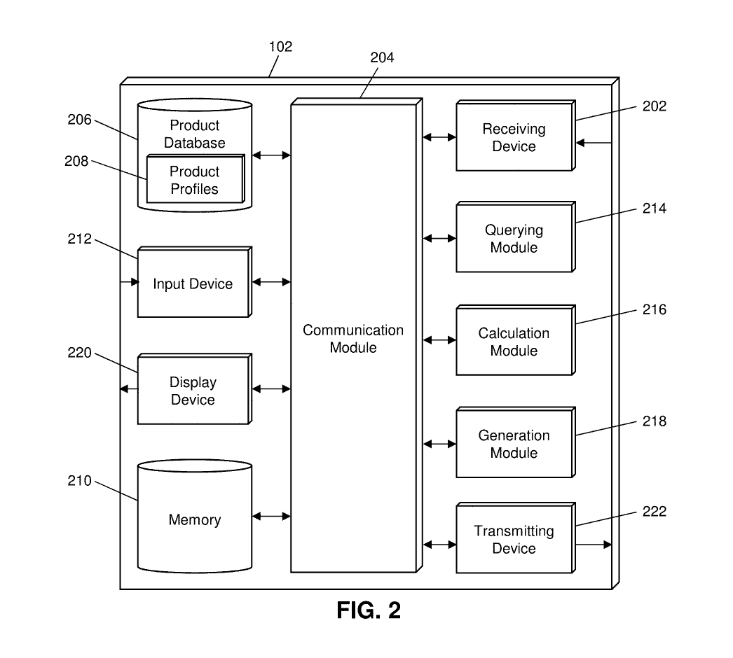

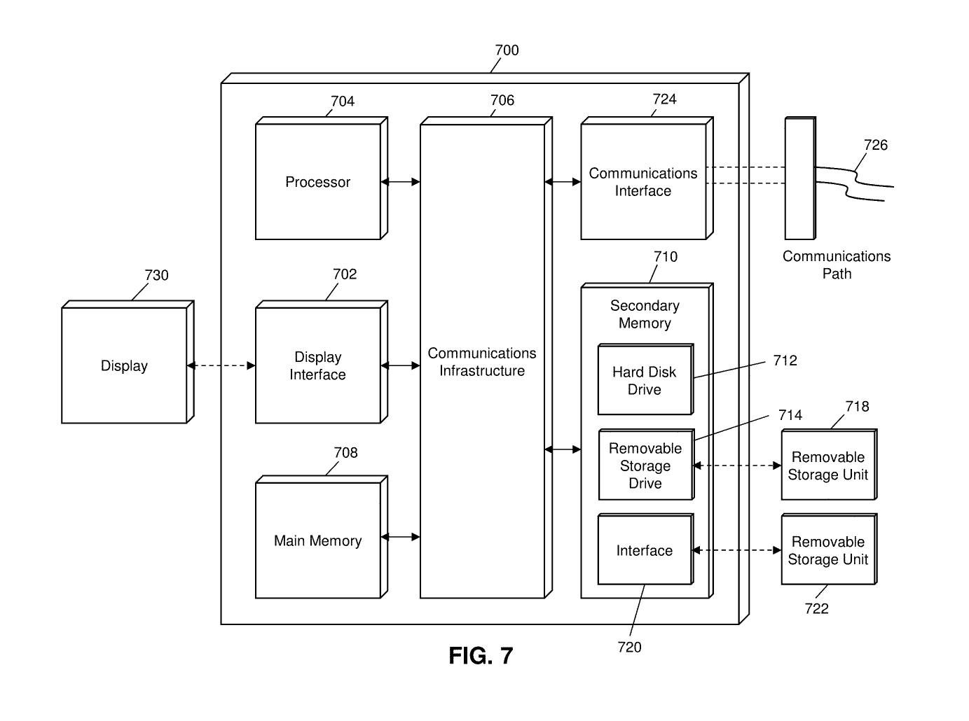

FIG. 2 illustrates an embodiment of a computing device 102 in the system 100. It will be apparent to persons having skill in the relevant art that the embodiment of the computing device 102 illustrated in FIG. 2 is provided as illustration only and may not be exhaustive to all possible configurations of the computing device 102 suitable for performing the functions as discussed herein. For example, the computer system 700 illustrated in FIG. 7 and discussed in more detail below may be a suitable configuration of the computing device 102.

The computing device 102 may include a receiving device 202. The receiving device 202 may be configured to receive data over one or more networks via one or more network protocols. In some instances, the receiving device 202 may be configured to receive data from processing servers 104, merchant systems 108, and other entities and devices via the Internet, near field communication, local area networks, etc. In some embodiments, the receiving device 202 may be comprised of multiple devices, such as different receiving devices for receiving data over different networks, such as a first receiving device for receiving data over a local area network and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by processing servers 104, which may be superimposed or otherwise encoded with indications of status for selected products, which may indicate if the corresponding product is pre-approved or is not approved. The receiving device 202 may also be configured to receive data signals electronically transmitted by merchant systems 108, which may be superimposed or otherwise encoded with data requests (e.g., requesting transaction data for a payment transaction) or transaction data, such as may be used by the computing device 102 if providing payment credentials for use in a payment transaction.

The computing device 102 may also include a communication module 204. The communication module 204 may be configured to transmit data between modules, engines, databases, memories, and other components of the computing device 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the computing device 102 and external components of the computing device 102, such as externally connected databases, display devices, input devices, etc. The computing device 102 may also include a processing device (not shown). The processing device may be configured to perform the functions of the computing device 102 discussed herein as will be apparent to persons having skill in the relevant art. In some embodiments, the processing device may include and/or be comprised of a plurality of engines and/or modules specially configured to perform one or more functions of the processing device, such as a querying module 214, calculation module 216, generation module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

The computing device 102 may also include a product database 206. The product database 206 may be configured to store a plurality of product profiles 208 using a suitable data storage format and schema. The product database 206 may be a relational database that utilizes structured query language for the storage, identification, modifying, updating, accessing, etc. of structured data sets stored therein. Each product profile 208 may be a structured data set configured to store data related to a product that may be purchased. Each product profile 208 may include at least the product identifier associated with the related product and an indication if the product is pre-approved. In some instances, a product profile 208 may also include additional data associated with the product, such as a product cost, which may be used in the calculation of a transaction amount for a payment transaction that includes the related product. In such instances, a product profile 208 may include a product cost for each of a plurality of different merchants at which the related product may be purchased, such as in instances where multiple merchants may sell the product at a different price. In these instances, the consumer 106 may select the merchant with which they are transacting for use of the associated product costs. In some cases, a product profile 208 may have a product cost that may serve as a limit, such that the related product may be pre-approved up to that product cost (e.g., to avoid overpaying). Merchant-specific product costs may be obtained using any suitable method, such as receiving the costs from merchant systems 108, the processing server 104, etc.

The computing device 102 may also include a memory 210. The memory 210 may be configured to store data for use by the computing device 102 in performing the functions discussed herein. The memory 210 may be configured to store data using suitable data formatting methods and schema and may be any suitable type of memory, such as read-only memory, random access memory, etc. The memory 210 may include, for example, encryption keys and algorithms, communication protocols and standards, data formatting standards and protocols, program code for modules and application programs of the processing device, and other data that may be suitable for use by the computing device 102 in the performance of the functions disclosed herein as will be apparent to persons having skill in the relevant art. In some embodiments, the memory 210 may be comprised of or may otherwise include a relational database that utilizes structured query language for the storage, identification, modifying, updating, accessing, etc. of structured data sets stored therein.

In some embodiments, the memory 210 may include program code for execution by the computing device 102 for one or more application programs, such as an application program used to provide the consumer 106 with a user interface for the selection of products for pre-approval and the checking of product status prior to initiating a payment transaction. In some instances, the memory 210 may also store program code for an electronic wallet application program, which may be configured to convey payment credentials to a merchant system 108 for use in a payment transaction. In such instances, payment credentials may be stored in the memory 210, and may be stored in a specific area of the memory 210, which may be a secure storage.

The computing device 102 may also include or be otherwise be interfaced with one or more input devices 212. The input devices 212 may be internal to the computing device 102 or external to the computing device 102 and connected thereto via one or more connections (e.g., wired or wireless) for the transmission of data to and/or from. The input devices 212 may be configured to receive input from a user of the computing device 102, such as the consumer 104, which may be provided to another module or engine of the processing server 102 (e.g., via the communication module 204) for processing accordingly. The input devices 212 may include any type of input device suitable for receiving input for the performing of the functions discussed herein, such as a keyboard, mouse, click wheel, scroll wheel, microphone, touch screen, track pad, camera, optical imager, etc. The input device 212 may be configured to, for example, receive input from the consumer 106 to select products for pre-approval in future payment transaction, as well as products for identification of pre-approval status during the selection of products prior to initiating a payment transaction. For instance, the computing device 102 may include a keyboard or touch screen to enable the selection of products for pre-approval for future transactions, and a camera for reading bar codes for products during selection and identification of status prior to purchase.

The computing device 102 may include a querying module 214. The querying module 214 may be configured to execute queries on databases to identify information. The querying module 214 may receive one or more data values or query strings, and may execute a query string based thereon on an indicated database, such as the product database 206, to identify information stored therein. The querying module 214 may then output the identified information to an appropriate engine or module of the computing device 102 as necessary. The querying module 214 may, for example, execute a query on the product database 206 to identify a product profile 208 related to a product being selected for purchase based on the product identifier included therein.

The computing device 102 may also include a calculation module 216. The calculation module 216 may be configured to perform calculations for the computing device 102 for performing functions thereof as discussed herein. The calculation module 216 may receive instructions for a calculation to be performed, may perform the calculation, and may output the result of the calculation to another module or engine of the computing device 102. For example, the calculation module 216 may be configured to calculate a transaction amount for a payment transaction based on product costs for one or more pre-approved products that are selected for purchase using the computing device 102.

The computing device 102 may also include a generation module 218. The generation module 218 may be configured to generate data signals and other data for use in performing the functions of the computing device 102 as discussed herein. The generation module 218 may receive an instruction, may generate data or a data signal based thereon, and may provide the generated data or data signal to another module or engine of the computing device 102. In some instances, the generation module 218 may receive data for inclusion in the data signals or used in the generation thereof as input. In other in instances, the generation module 218 may be configured to identify (e.g., via instruction to the querying module 214) data for usage. The generation module 218 may be configured to, for example, generate data signals for electronic transmission to the processing server 104 for registration of an account and product pre-approvals and for checking of status of products selected for purchase. The generation module 218 may also be configured to generate data signals for electronic transmission to merchant systems 108 to convey product identifiers and, if applicable, payment credentials and other transaction data for use in a payment transaction.

The computing device 102 may also include or be otherwise interfaced with a display device 220. The display device 220 may be internal to the computing device 102 or external to the computing device 102 and connected thereto via one or more connections (e.g., wired or wireless) for the transmission of data to and/or from. The display device 220 may be configured to display data to a user of the computing device 102, such as the consumer 106. The display device 220 may be any type of display suitable for displaying data as part of the functions discussed herein, such as a liquid crystal display, light emitting diode display, thin film transistor display, capacitive touch display, cathode ray tube display, light projection display, etc. In some instances, the computing device 102 may include multiple display devices 220. The display device 220 may be configured to, for example, display the indication for a product being selected for purchase that indicates if the product is pre-approved or not. The display device 220 may also be configured to display a transaction amount and other data for a payment transaction to be initiated based on selected, pre-approved products.

The computing device 102 may also include a transmitting device 222. The transmitting device 222 may be configured to transmit data over one or more networks via one or more network protocols. In some instances, the transmitting device 222 may be configured to transmit data to processing servers 104 and merchant systems 108, and other entities via the Internet, local area networks, near field communication, etc. In some embodiments, the transmitting device 222 may be comprised of multiple devices, such as different transmitting devices for transmitting data over different networks, such as a first transmitting device for transmitting data over the Internet and a second transmitting device for transmitting data over near field communication. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to processing servers 104 that are superimposed or otherwise encoded with product identifiers for checking for pre-approval. In some instances, transmissions to the processing server 104 may also include an account identifier associated with the consumer 106, transaction account, and/or the computing device 102. The transmitting device 222 may also be configured to electronically transmit data signals to merchant systems 108, which may be superimposed or otherwise encoded with product identifiers, and may also include transaction data for a payment transaction, such as payment credentials, a transaction amount, etc.

### Process for Identification of Pre-Approved Products

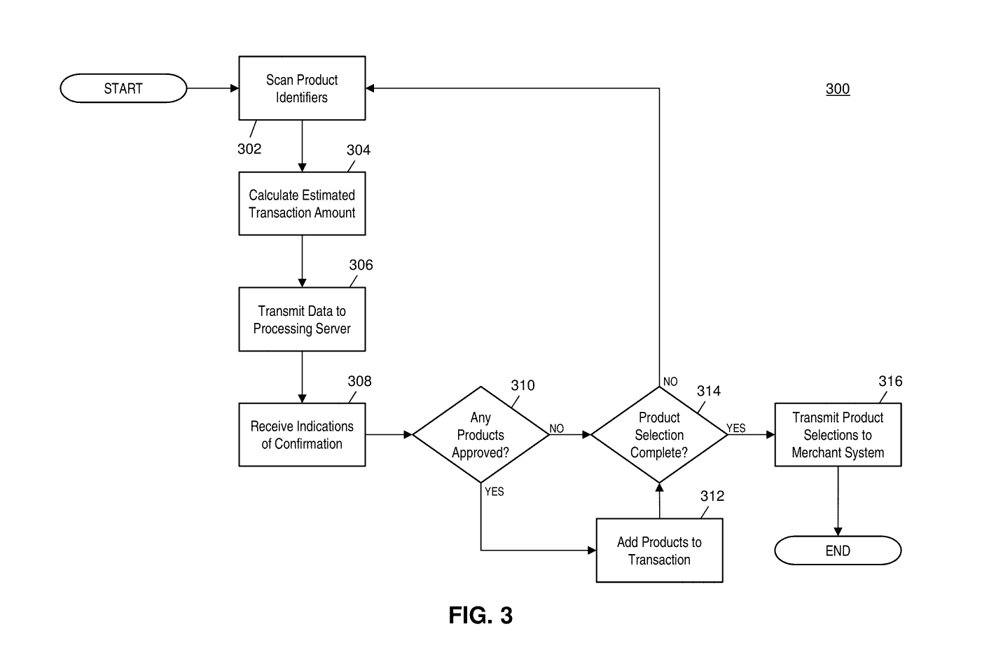

FIG. 3 illustrates a process 300 for the identification of pre-approved products for purchase in a payment transaction with a limited use account using the computing device 102.

In step 302, the input device 212 of the computing device 102 may scan a machine-readable code displayed for products selected for purchase that are encoded with a product identifier associated with the respective product and may decode the product identifiers therefrom. As part of the scanning of the product identifiers, the querying module 214 of the computing device 102 may execute a query on the product database 206 to identify a product profile 208 related to each product based on the respective product identifier. In step 304, the calculation module 216 of the processing server 102 may calculate an estimated transaction amount for the payment transaction based on a product cost for each of the selected products as included in the identified product profile 208, which may be added to a previously calculated transaction amount if prior products were selected.

In step 306, the transmitting device 222 of the computing device 102 may electronically transmit a data signal (e.g., generated via the generation module 218 of the processing server) to the processing server 104 that is superimposed or otherwise encoded with at least the product identifier for each selected product. In some instances, the data signal may also include the calculated transaction amount and/or an account identifier associated with the consumer 106, computing device 102, or a related transaction account. In step 308, the receiving device 202 of the processing server 102 may receive indications from the processing server 104 for each of the selected products, which may indicate if the product is a pre-approved product or if the product is not allowed for purchase.

In step 310, the computing device 102 may determine if any of the selected products are pre-approved for purchase based on the received indications. If at least one product is approved, then, in step 312, the corresponding product identifier for each approved product may be added to a list of products for the payment transaction (e.g., stored in the memory 210) and the transaction amount for the payment transaction may be calculated by the calculation module 216 based on the addition of the new product or products. Once the pre-approved products have been added, or if no pre-approved products were identified, then, in step 314, the computing device 102 may determine if the selection of products for the payment transaction is complete. The determination may be based on, for example, receipt of an instruction from the consumer 106 via the input device 212 that indicates that the selection is completed. If the selection is not completed, where more products may be selected, then the process 300 may return to step 302 where new products may be scanned. If the selection is completed, then, in step 316, the transmitting device 222 of the computing device 102 may electronically transmit at least the product identifiers for the selected, pre-approved products to the merchant system 108 for use in a subsequent payment transaction. In some embodiments, the transmitting device 222 may also electronically transmit payment credentials for use in funding the payment transaction to the merchant system 108.

### Graphical User Interface

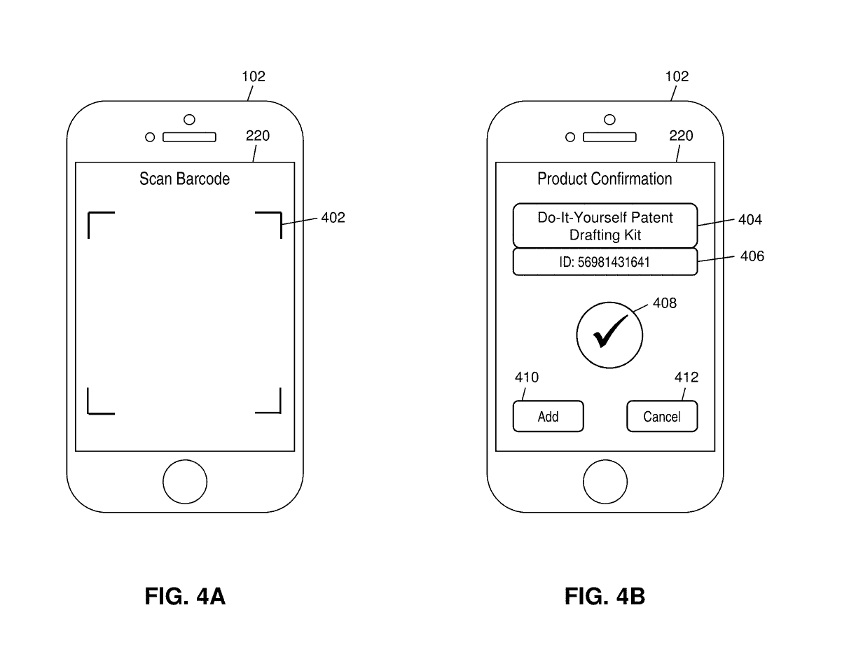

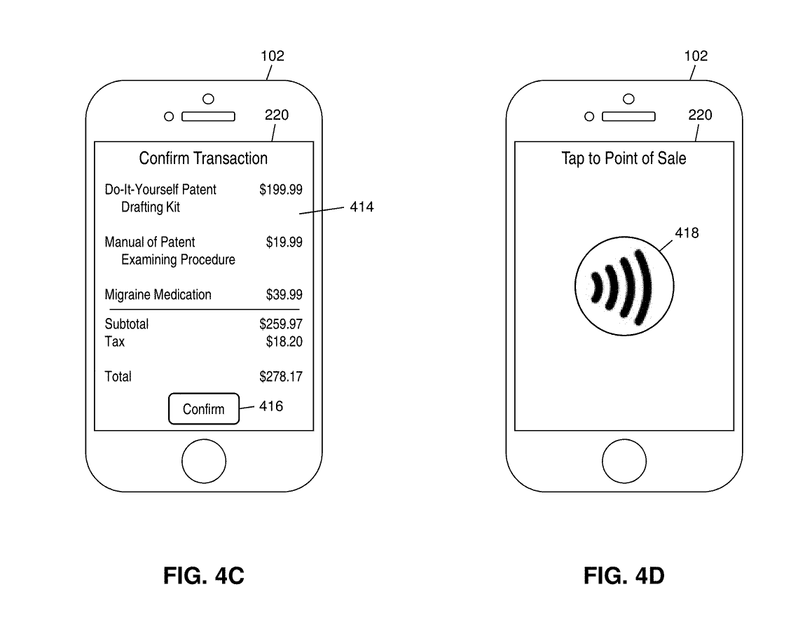

FIGS. 4A-4D illustrate an exemplary graphical user interface of the computing device 102 for interfacing with the consumer 106 as a user of the computing device 102 for performing the functions discussed herein. It will be apparent to persons having skill in the relevant art that the interface illustrated in FIGS. 4A-4D is provided as an illustration only and that alternative interfaces may be used in the performance of functions of the computing device 102 as discussed herein.

FIG. 4A illustrates an interface of the computing device 102 where the display device 220 thereof may display a screen for the consumer 106 to scan a machine-readable code of a product selected for purchase for which pre-approval status is to be identified. The display device 220 may display a reticule 402, which may indicate an area in which the consumer 106 may position the product's machine-readable code to be read by the input device 212 of the computing device 102. The consumer 106 may then position the product's machine-readable code inside the reticule, where the encoded product identifier may then be read and decoded by the input device 212.

FIG. 4B illustrates an interface of the computing device 102 following the reading of a product identifier for a selected product. As illustrated in FIG. 4B, the consumer 106 may be presented with a screen that indicates the pre-approval status of the selected product. The display device 220 may display a product name 404, which may be used by the consumer 106 to confirm that the scanned product is the product that is intended for purchase. The display may also include the product identifier 406, which may also be used for confirmation by the consumer of the scanned product. The display may further include an indication 408. The indication 408 may indicate the status of the selected product as pre-approved or not pre-approved. In the illustrated example, the indication 408 displays a checkmark, which indicates that the selected product is pre-approved for purchase.

The display may also include an add button 410 and a cancel button 412. The add button 410, when interacted with by the consumer 106, may result in the selected product being added to the current list of products selected for purchase in the subsequent payment transaction. In some cases, interaction with the add button 410 may add the product to a list of pre-approved products (e.g., stored locally in the computing device 102) for future usage or reference. In some instances, the add button 410 may not be displayed or may be disabled if the indication 408 is such that the selected product is not pre-approved. The cancel button 412, when interacted with by the consumer 106, may result in the selected product being discarded and not added to the list of products for purchase.

FIG. 4C illustrates an interface of the computing device 102 that displays a list of products 414 selected for purchase in a subsequent payment transaction. The list of products 414 may include each of the pre-approved products that were added to the transaction by the consumer 106 and may include a product cost for each product (e.g., identified in the related product profile 208 in the product database 206 of the computing device 102). The list of products 414 may also include a transaction amount calculated for the selected products by the calculation module 216 of the computing device 102, which, in the illustrated example, may also include a subtotal and tax amount for the transaction used to calculate the total transaction amount. The display may also include a confirm button 416, which, when interacted with by the consumer 106, may initiate the electronic transmission of the product identifiers to the merchant system 108.

When the consumer 106 interacts with the confirm button 416, the display device 220 may display the screen illustrated in FIG. 4D. The screen may indicate to the consumer 106 that the computing device 102 is ready for the transmission of the product identifiers and any additional data, such as payment credentials, to the merchant system 108. The screen may include, as illustrated in FIG. 4D, an indicator 418 that indicates that the computing device 102 is awaiting a merchant system 108 for receipt of the product identifiers and other associated data. The consumer 106 may then move the computing device 102 near a receiving device of the merchant system 108, such as a point of sale device, for electronic transmission of the data thereto using near field communication or another suitable communication method.

### Exemplary Method for Identification of Pre-Approved Products in a Limited Use Account

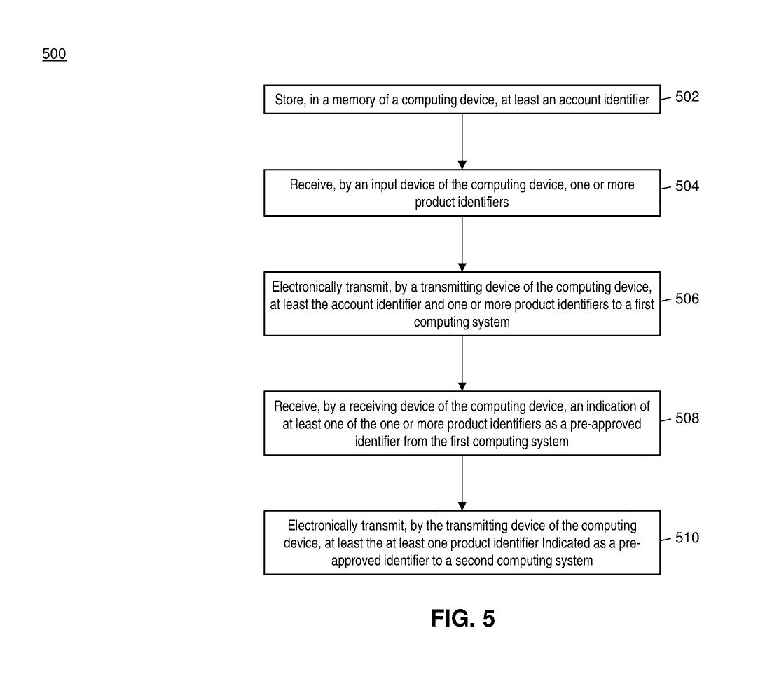

FIG. 5 illustrates a method 500 for the identification of products that are pre-approved for purchase with a limited use account in a subsequent payment transaction, prior to the initiation of the payment transaction.

In step 502, at least an account identifier may be stored in a memory (e.g., the memory 210) of a computing device (e.g., the computing device 102). In step 504, one or more product identifiers may be received by an input device (e.g., the input device 212) of the computing device. In step 506, at least the account identifier and one or more product identifiers may be electronically transmitted by a transmitting device (e.g., the transmitting device 222) of the computing device to a first computing system (e.g., the processing server 104).

In step 508, an indication of at least one of the one or more product identifiers as a pre-approved identifier may be received by a receiving device (e.g., the receiving device 202) of the computing device from the first computing system. In step 510, at least one product identifier indicated as a pre-approved identifier may be electronically transmitted by the transmitting device of the computing device to a second computing system (e.g., the merchant system 108).

In one embodiment, the account identifier and one or more product identifiers may be electronically transmitted to the first computing system using a first communication method, and the at least one product identifier indicated as a pre-approved identifier may be electronically transmitted to the second computing system using a second communication method. In a further embodiment, the first communication method may be one of: a cellular communication network and the Internet, and the second communication method may be near field communication.

In some embodiments, the memory may further include a payment token associated with the account identifier; and electronically transmitting the at least one product identifier to the second computing system may further include electronically transmitting the payment token to the second computing system. In one embodiment, the input device may be an optical imaging device configured to image and decode, for each of the one or more product identifiers, a machine-readable code encoded with the respective product identifier.

In some embodiments, the method 500 may further include repeating the first electronically transmitting step and the second receiving step at least once prior to electronically transmitting the at least one product identifier indicated as a pre-approved identifier to the second computing system. In one embodiment, the method 500 may also include storing, in the memory of the computing device, product profiles (e.g., product profiles 208) for a plurality of products, wherein each product profile includes at least the associated product identifier and a product cost; executing, by a querying module (e.g., the querying module 214) of the computing device, a query on the memory to identify, for each of the one or more product identifiers, a corresponding product profile that includes the respective product identifier; and calculating, by a calculation module (e.g., the calculation module 216) of the computing device, an estimated transaction amount based on at least the product cost included in each of the identified corresponding product profiles, wherein electronically transmitting the account identifier and one or more product identifiers to the first computing system further includes electronically transmitting the estimated transaction amount.

In some embodiments, the method 500 may further include: receiving, by the receiving device of the computing device, a transaction confirmation, wherein the transaction confirmation includes at least the at least one product identifier indicated as a pre-approved identifier; and storing, in the memory of the computing device, the received transaction confirmation. In a further embodiment, the method 500 may even further include displaying, by a display device (e.g., the display device 220) of the computing device, the received transaction confirmation. In another further embodiment, the transaction confirmation may be received from the first computing system.

### Payment Transaction Processing System and Process

FIG. 6 illustrates a transaction processing system and a process 600 for the processing of payment transactions in the system, which may include the processing of thousands, millions, or even billions of transactions during a given period (e.g., hourly, daily, weekly, etc.). The process 600 and steps included therein may be performed by one or more components of the system 100 discussed above, such as the computing device 102, processing server 104, consumer 106, merchant system 108, payment network 110, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3 and 5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8683 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution 610 may generate an authorization request for the payment transaction based on the formatted transaction data. The authorization request may be a specially formatted transaction message that is formatted pursuant to one or more standards, such as the ISO 8683 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 660, assuming the transaction was approved, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 612. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the computing device 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 5, and 6.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3, 5, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for identification of pre-approved products in a limited use account. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identification of pre-approved products in a limited use account, comprising:
storing, in a memory of a computing device, at least an account identifier;
receiving, by an input device of the computing device, one or more product identifiers;
electronically transmitting, by a transmitting device of the computing device, at least the account identifier and one or more product identifiers to a first computing system;
receiving, by a receiving device of the computing device, an indication of at least one of the one or more product identifiers as a pre-approved identifier from the first computing system; and
electronically transmitting, by the transmitting device of the computing device, at least the at least one product identifier indicated as a pre-approved identifier to a second computing system.

2. The method of claim 1, wherein
the account identifier and one or more product identifiers are electronically transmitted to the first computing system using a first communication method, and
the at least one product identifier indicated as a pre-approved identifier is electronically transmitted to the second computing system using a second communication method.

3. The method of claim 2, wherein
the first communication method is one of: a cellular communication network and the Internet, and
the second communication method is near field communication.

4. The method of claim 1, wherein
the memory further includes a payment token associated with the account identifier; and
electronically transmitting the at least one product identifier to the second computing system further includes electronically transmitting the payment token to the second computing system.

5. The method of claim 1, wherein the input device is an optical imaging device configured to image and decode, for each of the one or more product identifiers, a machine-readable code encoded with the respective product identifier.

6. The method of claim 1, further comprising:
repeating the first electronically transmitting step and the second receiving step at least once prior to electronically transmitting the at least one product identifier indicated as a pre-approved identifier to the second computing system.

7. The method of claim 1, further comprising:
storing, in the memory of the computing device, product profiles for a plurality of products, wherein each product profile includes at least the associated product identifier and a product cost;
executing, by a querying module of the computing device, a query on the memory to identify, for each of the one or more product identifiers, a corresponding product profile that includes the respective product identifier; and
calculating, by a calculation module of the computing device, an estimated transaction amount based on at least the product cost included in each of the identified corresponding product profiles, wherein
electronically transmitting the account identifier and one or more product identifiers to the first computing system further includes electronically transmitting the estimated transaction amount.

8. The method of claim 1, further comprising:
receiving, by the receiving device of the computing device, a transaction confirmation, wherein the transaction confirmation includes at least the at least one product identifier indicated as a pre-approved identifier; and
storing, in the memory of the computing device, the received transaction confirmation.

9. The method of claim 8, further comprising:
displaying, by a display device of the computing device, the received transaction confirmation.

10. The method of claim 8, wherein the transaction confirmation is received from the first computing system.

11. A system for identification of pre-approved products in a limited use account, comprising:
a memory of a computing device configured to store at least an account identifier;
an input device of the computing device configured to receive one or more product identifiers;
a transmitting device of the computing device configured to electronically transmit at least the account identifier and one or more product identifiers to a first computing system; and
a receiving device of the computing device configured to receive an indication of at least one of the one or more product identifiers as a pre-approved identifier from the first computing system, wherein
the transmitting device of the computing device is further configured to electronically transmit at least the at least one product identifier indicated as a pre-approved identifier to a second computing system.

12. The system of claim 11, wherein
the account identifier and one or more product identifiers are electronically transmitted to the first computing system using a first communication method, and
the at least one product identifier indicated as a pre-approved identifier is electronically transmitted to the second computing system using a second communication method.

13. The system of claim 12, wherein
the first communication method is one of: a cellular communication network and the Internet, and
the second communication method is near field communication.

14. The system of claim 11, wherein
the memory is further configured to store a payment token associated with the account identifier; and
electronically transmitting the at least one product identifier to the second computing system further includes electronically transmitting the payment token to the second computing system.

15. The system of claim 11, wherein the input device is an optical imaging device configured to image and decode, for each of the one or more product identifiers, a machine-readable code encoded with the respective product identifier.

16. The system of claim 11, wherein the transmitting device and receiving device are configured to repeat the first electronic transmission using additional product identifiers and the receipt of indications at least once prior to electronically transmitting the at least one product identifier indicated as a pre-approved identifier to the second computing system.

17. The system of claim 11, further comprising:
a memory of the computing device configured to store product profiles for a plurality of products, wherein each product profile includes at least the associated product identifier and a product cost;
a querying module of the computing device configured to execute a query on the memory to identify, for each of the one or more product identifiers, a corresponding product profile that includes the respective product identifier; and
a calculation module of the computing device configured to calculate an estimated transaction amount based on at least the product cost included in each of the identified corresponding product profiles, wherein
electronically transmitting the account identifier and one or more product identifiers to the first computing system further includes electronically transmitting the estimated transaction amount.

18. The system of claim 11, wherein
the receiving device of the computing device is further configured to receive a transaction confirmation, wherein the transaction confirmation includes at least the at least one product identifier indicated as a pre-approved identifier, and
the memory of the computing device is further configured to store the received transaction confirmation.

19. The system of claim 18, further comprising:
a display device of the computing device configured to display the received transaction confirmation.

20. The system of claim 18, wherein the transaction confirmation is received from the first computing system.
